(19) United States
(12) Patent Application Publication
(10) Pub. No.: US 2024/0406526 A1
(43) Pub. Date: Dec. 5, 2024

(54) Detecting an Occlusion of an Image Sensor

(71) Applicant: Apple Inc., Cupertino, CA (US)

(72) Inventors: Huiwen Guo, Newark, CA (US); Florian Mahlknecht, San Francisco, CA (US); Jose Lamarca Peiro, Munich (DE); Lina M. Paz-Perez, Santa Clara, CA (US); Oleg Naroditsky, San Francisco, CA (US)

(21) Appl. No.: 18/678,972

(22) Filed: May 30, 2024

Related U.S. Application Data
(60) Provisional application No. 63/470,518, filed on Jun. 2, 2023.

(51) Int. Cl. H04N 23/52; G01S 7/497; G01S 17/66; G01S 17/894; G02B 27/00

(52) U.S. Cl. CPC H04N 23/52; G01S 7/497; G01S 17/66; G01S 17/894; G02B 27/0006; G01S 2007/4977

(57) ABSTRACT

A method for detecting an occlusion of an image sensor includes obtaining, via the image sensor, a plurality of images of a physical environment of the electronic device while the electronic device is moving. The method includes detecting an occlusion of the image sensor based on a repeated occurrence of a static feature across the plurality of images. The method includes modifying a weight associated with the static feature to decrease an impact of the occlusion on a performance of a function.

### CROSS-REFERENCE TO RELATED APPLICATION

This application claims the benefit of U.S. Provisional Patent App. No. 63/470,518, filed on Jun. 2, 2023, which is incorporated by reference in its entirety.

### TECHNICAL FIELD

The present disclosure generally relates to detecting an occlusion of an image sensor.

### BACKGROUND

Some devices include an image sensor. A user can use the image sensor to capture images or videos. Sometimes the image sensor is occluded. Occlusions of the image sensor can reduce a quality of the image or video that the image sensor captures. Images captured by the image sensor are sometimes used for downstream operations. Occlusions of the image sensor may adversely impact a result of the downstream operations performed on the images captured by the image sensor.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1G are diagrams of an example operating environment in accordance with some implementations.

FIG. 2A is a diagram of an occlusion detection system in accordance with some implementations.

FIG. 2B is a diagram of a look-up table in accordance with some implementations.

FIG. 3 is a flowchart representation of a method of detecting an occlusion of an image sensor in accordance with some implementations.

FIG. 4 is a block diagram of a device that detects an occlusion of an image sensor in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for detecting an occlusion of an image sensor. In some implementations, a method is performed by an electronic device including a non-transitory memory, one or more processors, a display and an image sensor. In various implementations, a method includes obtaining, via the image sensor, a plurality of images of a physical environment of the electronic device while the electronic device is moving. In some implementations, the method includes detecting an occlusion of the image sensor based on a repeated occurrence of a static feature across the plurality of images. In some implementations, the method includes modifying a weight associated with the static feature to decrease an impact of the occlusion on a performance of a function.

In accordance with some implementations, a device includes one or more processors, a plurality of sensors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Some devices are capable of constructing and updating a map of an environment. Some devices are capable of tracking an object. Devices may utilize methods and/or systems associated with simultaneous localization and mapping (SLAM) in order to construct a map of an environment, update the map of the environment, and/or track a location of an object in the environment. SLAM utilizes images captured by an image sensor. Some image sensors are covered by a cover glass that serves to protect their lens. Sometimes occlusions appear on the cover glass. Occlusions may include material that is deposited on a surface of the cover glass (e.g., smudges) and/or abrasions of the cover glass (e.g., scratches). Occlusions can result in artifacts that interfere with SLAM.

The present disclosure provides methods, systems, and/or devices for detecting an occlusion of an image sensor based on a repeated occurrence of a static feature across a series of images captured by the image sensor while the image sensor is moving. A device obtains images captured by an image sensor while the device is moving. After capturing an image, the device performs feature detection and extraction to generate point clouds. If a point appears static across a series of images while the device is moving, the device determines that the point is a result of an occlusion such as a smudge or a scratch. The device modifies a weight of the static point to decrease an impact of the static feature on a performance of a function. For example, the device may assign a relatively low weight to the static point for SLAM, for example, by discarding the static point for SLAM.

The device can use a two-dimensional (2D) lookup table (LUT) to track repeated occurrences of points across the series of the images captured by the image sensor. Points that appear more than a threshold number of times within a given amount of time during device movement may be considered static points. For example, a point that appears more than 40 times within a 10 millisecond window during constant movement of the device may be classified as a static point resulting from an occlusion.

Occlusion detection may be a resource-intensive operation. As such, the device may perform occlusion detection when an occlusion detection criterion is satisfied and the device may forgo performing occlusion detection when the occlusion detection criterion is not satisfied. For example, the device may perform occlusion detection when an ambient light level is below a threshold light level. For example, the device may perform occlusion detection during low light conditions because low light conditions tend to exacerbate the effect of occlusions on SLAM. As another example, the device may perform occlusion detection when the device includes an infrared light (IR) illuminator. The device may include an IR illuminator that is located proximate to the image sensor. IR light may reflect off the cover glass and be detected by the image sensor thereby exacerbating the effect of occlusions during low light conditions.

The device may classify the occlusion into different types of occlusions. For example, the device may classify the occlusion as a smudge or a scratch. The classification may be based on an intensity of the static feature (e.g., a density of points that collectively form the static feature) and/or a shape of the static feature. For example, smudges may appear dull with a relatively low density of points whereas scratches may appear bright with a relatively high density of points. As another example, smudges may be circular or oval, whereas scratches may be linear. More generally, the device may classify the occlusion based on a property of the occlusion, for example, based on a shape, a gradient and/or an intensity of the occlusion. Additionally or alternatively, the device may classify the occlusion based on detected keypoint attributes in the occlusion region, for example, based on keypoint orientation, scale and/or saliency.

The device may generate a notification when the occlusion satisfies a notification criterion. For example, the device may generate a notification notifying the user to clean the image sensor in order to remove the occlusions (e.g., smudges). The device may prompt the user to clean the image sensor when a number of occlusions exceeds a threshold and/or when a percentage of the image sensor that is occluded exceeds a threshold percentage. As another example, the device may generate a notification to replace the device when a number of scratches exceeds a threshold number or when an amount of scratches exceeds a threshold amount (e.g., when more than a threshold percentage area of the cover glass is scratched).

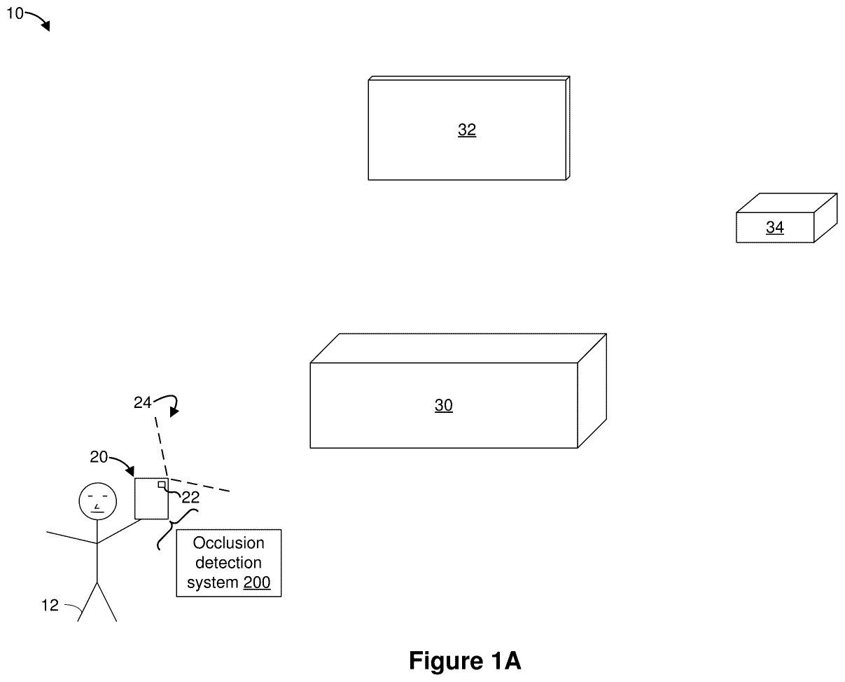

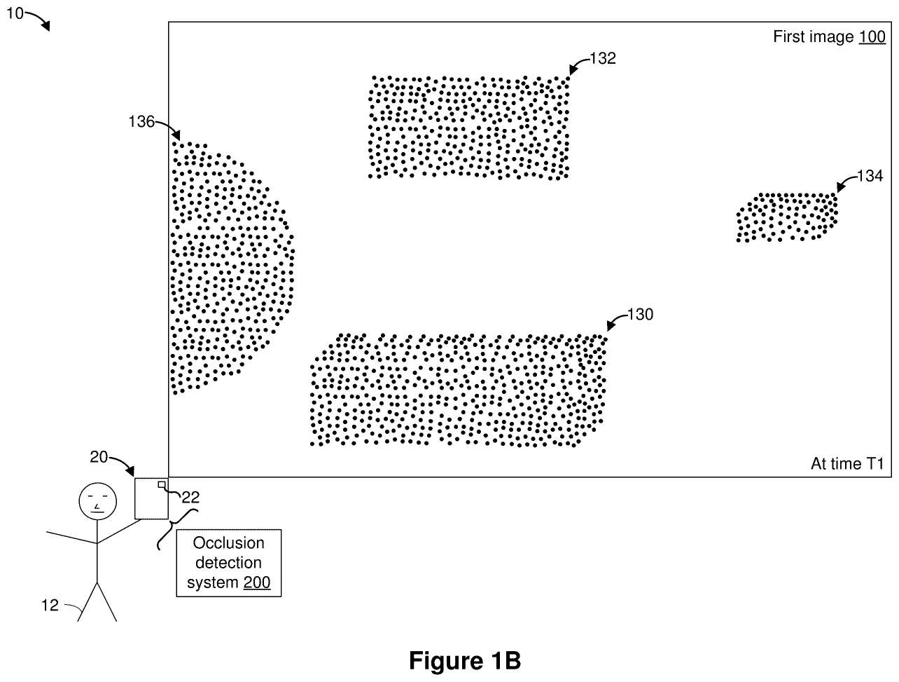

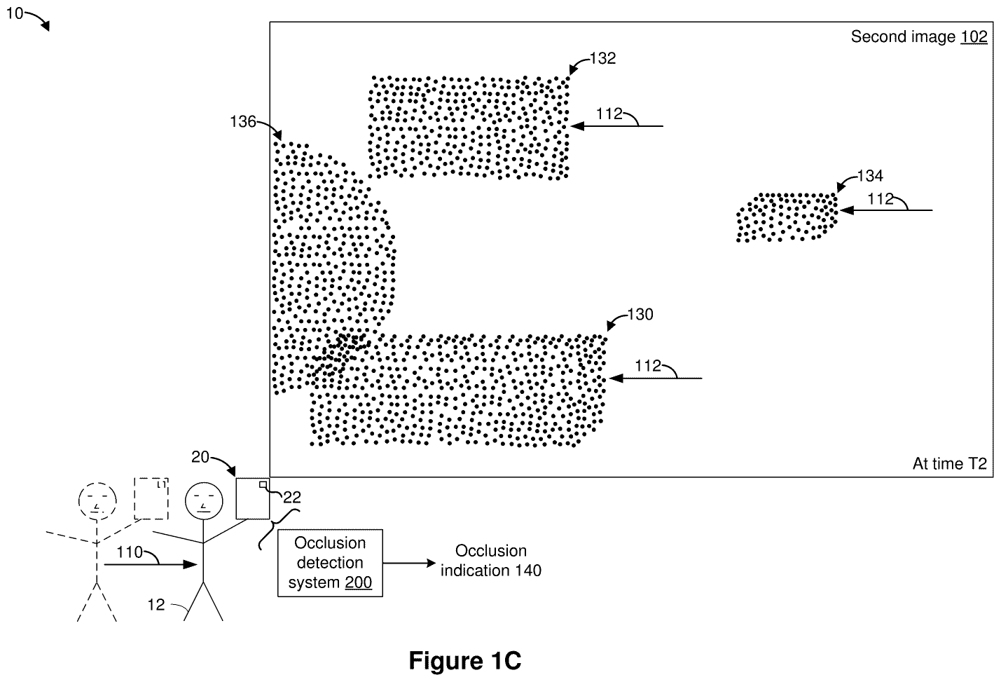

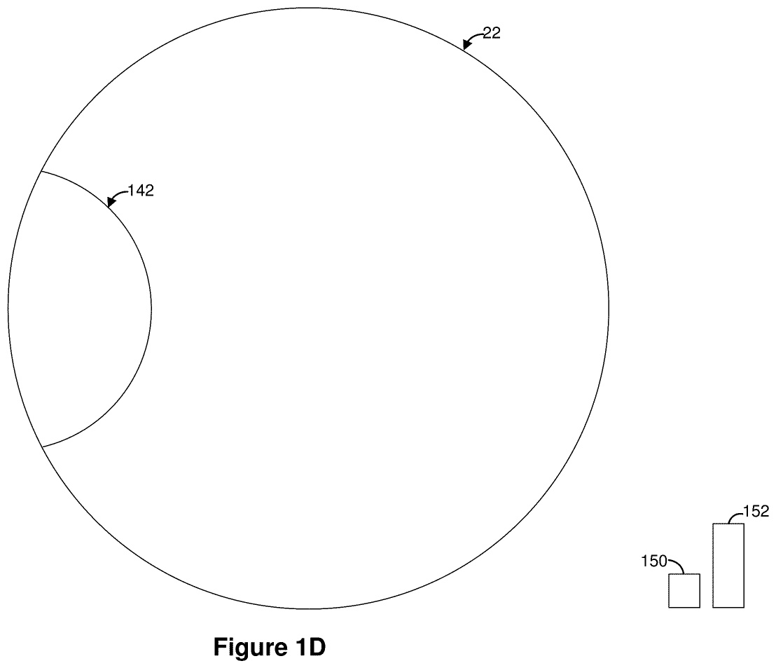

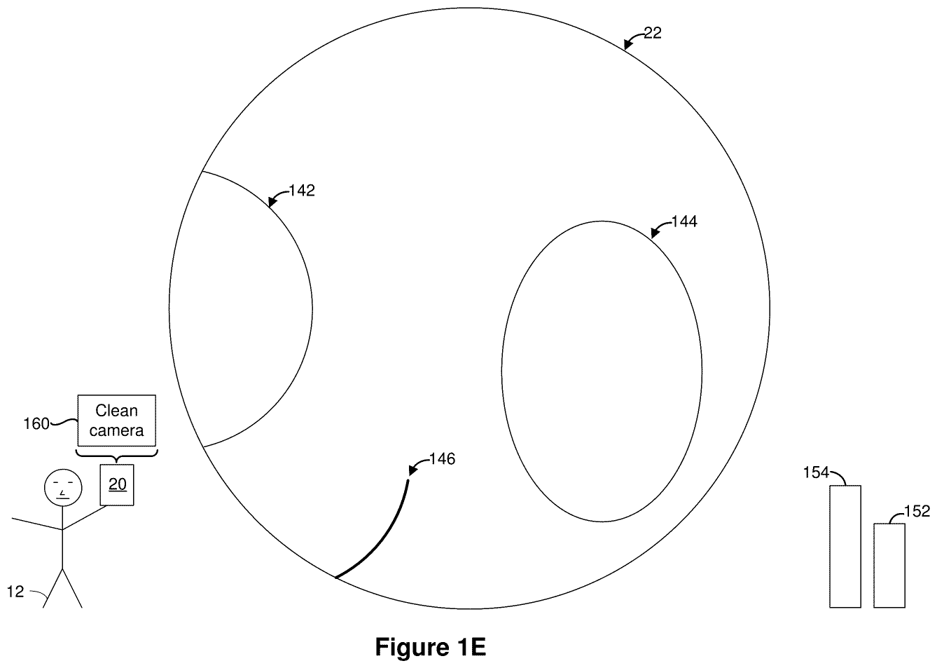

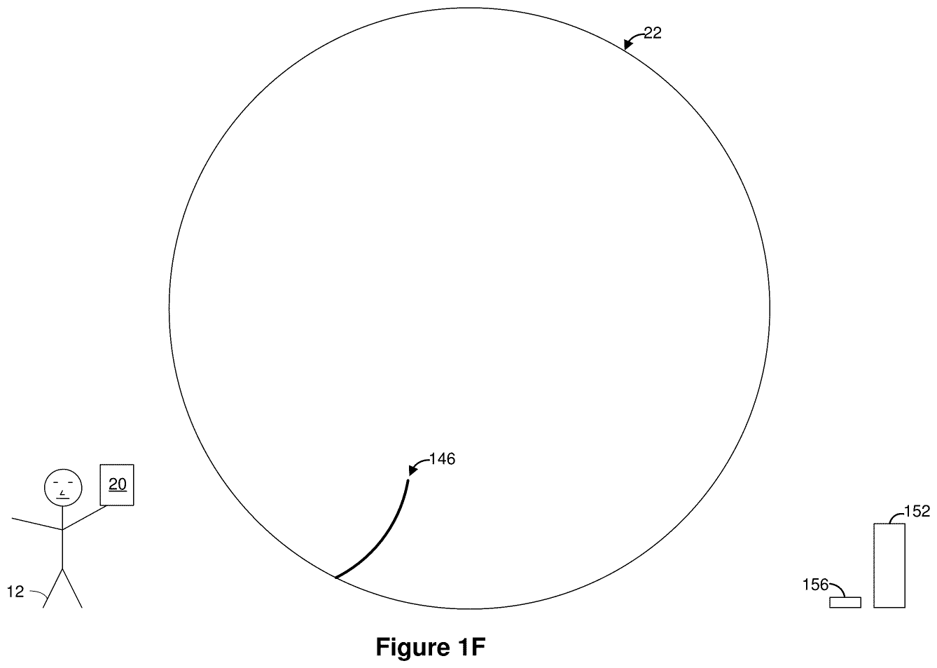

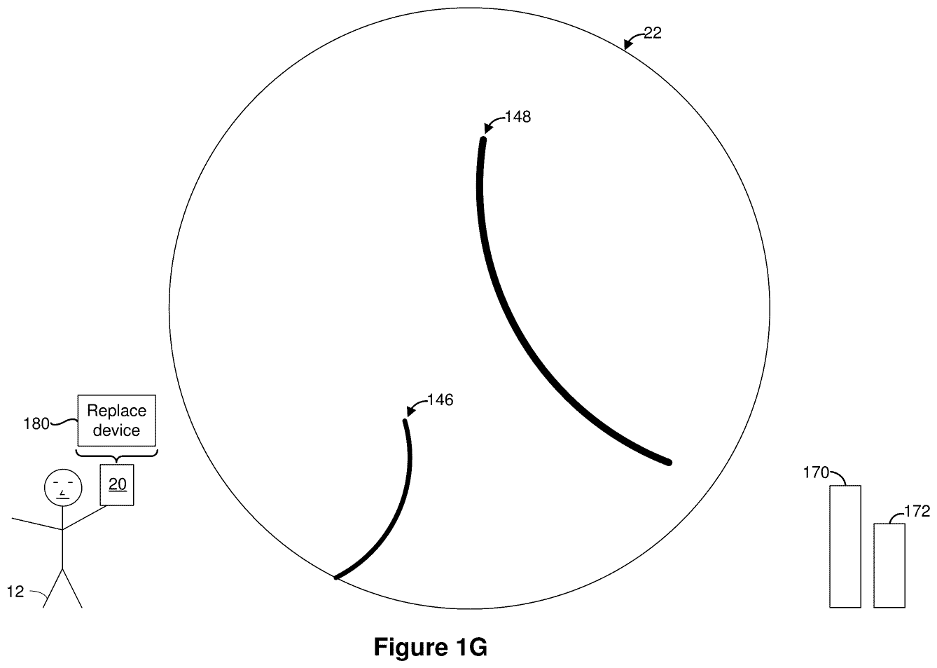

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the physical environment 10 includes a user 12, an electronic device 20 and an occlusion detection system 200.

In various implementations, the electronic device 20 includes an image sensor 22 with a corresponding field-of-view 24. In some implementations, the image sensor 22 includes a front-facing camera, for example, a scene-facing camera. In some implementations, the image sensor 22 includes a visible light camera. In some implementations, the image sensor 22 includes an infrared (IR) light camera. In various implementations, the image sensor 22 is covered by a cover glass (not shown). The cover glass may be designed and positioned to protect the image sensor 22 from the environment. In some implementations, the electronic device 20 includes an IR illuminator (not shown) that may be placed adjacent to the image sensor 22. In some implementations, the cover glass covers the image sensor 22 and the IR illuminator. As such, IR light emitted by the IR illuminator may reflect off the cover glass and be captured by the image sensor 22. Alternatively, the IR illuminator may be distant from the image sensor 22. For example, in some implementations, the cover glass does not cover the IR illuminator.

In some implementations, the physical environment 10 includes various physical objects. In the example of FIG. 1A, the physical environment 10 includes a couch 30, a television 32 and a drone 34. In some implementations, the electronic device 20 utilizes images captured by the image sensor 22 to generate and/or update a map of the physical environment 10. The electronic device 20 may utilize methods and/or systems associated with simultaneous localization and mapping (SLAM) to generate and/or update the map of the physical environment 10. In some implementations, the electronic device 20 utilizes the images captured by the image sensor 22 to track a location of a physical object in the physical environment 10. For example, the electronic device 20 may utilize images captured by the image sensor to track a location of the drone 34 within the physical environment 10. The electronic device 20 may utilize methods and/or systems associated with SLAM to track the location of various physical objects in the physical environment 10.

As the user 12 uses the electronic device 20, the user 12 may inadvertently touch the cover glass covering the image sensor 22 with his/her fingers. As such, oils from the fingers may get deposited on the cover glass and may result in smudges on the cover glass. The smudges may occlude the field of view 24 of the image sensor 22. Additionally or alternatively, the cover glass may get scratched during daily use of the electronic device 20. For example, if the user 12 accidentally drops the electronic device 20 on the floor or the user 12 slides the electronic device 20 along a rough surface, the cover glass may get scratched. Occlusions such as smudges and/or scratches may appear as features during feature detection and extraction, and interfere with a performance of a function such as object detection and/or SLAM operations (e.g., mapping and/or object tracking).

As described herein, in various implementations, the occlusion detection system 200 detects occlusions of the image sensor 22 and mitigates the adverse effects of the detected occlusions on images. In some implementations, the electronic device 20 includes (e.g., implements) the occlusion detection system 200. Alternatively, in some implementations, the occlusion detection system 200 is separate from the electronic device 20. In some implementations, the electronic device 20 includes a handheld computing device such as a smartphone, a tablet, a laptop or a media player, and the image sensor 22 is a rear-facing camera or a front-facing camera. Alternatively, in some implementations, the electronic device 20 includes a wearable computing device such as a watch or a head-mountable device (HMD), and the image sensor 22 is a scene-facing camera.

Referring to FIG. 1B, the image sensor 22 captures a first image 100 at a first time T1. The electronic device 20 performs feature detection and extraction on the first image 100 in order to detect and extract features from the first image 100. In some implementations, the features include point clouds. For example, as shown in FIG. 1B, the electronic device 20 generates a first point cloud 130 that corresponds to the couch 30 shown in FIG. 1A, a second point cloud 132 that corresponds to the television 32 shown in FIG. 1A, a third point cloud 134 that corresponds to the drone 34 shown in FIG. 1A, and a fourth point cloud 136 that does not correspond to a physical object in the physical environment 10 shown in FIG. 1A. In some implementations, points in the point clouds 130, 132, 134 and 136 are referred to as key points.

Referring to FIG. 1C, the image sensor 22 captures a second image 102 at a second time T2 that occurs after the first time T1 shown in FIG. 1B. The second image 102 depicts the physical environment 10 from a different point of view (POV) than the first image 100 shown in FIG. 1A. For example, the image sensor 22 captures the first image 100 (shown in FIG. 1A) from a first POV and the image sensor 22 captures the second image 102 from a second POV that is different from the first POV. FIG. 1C illustrates a user movement 110 between the first time T1 when the image sensor 22 captured the first image 100 and the second time T2 when the image sensor 22 captured the second image 102. FIG. 1C further illustrates a point cloud movement 112 of the points clouds 130, 132 and 134. As illustrated in FIG. 1C, the point cloud movement 112 is in an opposite direction of the user movement 110. For example, as the user 12 and the electronic device 20 move towards the right, the point clouds 130, 132 and 134 move towards the left. While FIG. 1C illustrates a translation of the electronic device 20, in some implementations, movement of the electronic device 20 includes a combination of a translation and a rotation (e.g., a translation, a rotation, or a translation and a rotation that occur concurrently).

In the example of FIGS. 1B and 1C, there is no movement of the fourth point cloud 136 between the first image 100 and the second image 102. The fourth point cloud 136 is stationary between the first image 100 and the second image 102. In some implementations, the occlusion detection system 200 determines whether the fourth point cloud 136 corresponds to an occlusion (e.g., a smudge on the cover glass covering the image sensor 22) by tracking a movement of the fourth point cloud 136 over a series of images captured within a duration of time (e.g., 40 milliseconds). In some implementations, if the fourth point cloud 136 appears static over the series of images captured within the duration of time, the occlusion detection system 200 generates an occlusion indication 140 indicating that the fourth point cloud 136 corresponds to an occlusion and not a physical object in the physical environment 10. As will be described later, in some implementations, the occlusion detection system 200 utilizes a 2D LUT to track repeated occurrences of key points. When a number of repeated occurrences of a key point exceeds a threshold number, the occlusion detection system 200 may determine that the key point is static and corresponds to an occlusion.

In various implementations, the occlusion detection system 200 mitigates the effect of an occlusion that results in static features by lowering a weight assigned to the static features in downstream operations. In some implementations, the occlusion detection system 200 mitigates the effect of static key points by lowering respective weights assigned to static key points in SLAM operations. In some implementations, lowering the respective weights of the static key points includes discarding the key points altogether. In the example of FIG. 1C, the occlusion detection system 200 may mitigate the effect of the occlusion resulting in the static fourth point cloud 136 by lowering a weight assigned to the points in the fourth point cloud 136. In some implementations, the occlusion detection system 200 assigns a weight of zero to the points in the fourth point cloud 136 thereby discarding the fourth point cloud 136 altogether.

FIG. 1D illustrates an expanded view of the image sensor 22. As illustrated in FIG. 1D, a first occlusion 142 occludes the image sensor 22. The first occlusion 142 corresponds to the fourth point cloud 136 shown in FIGS. 1B and 1C. In some implementations, the first occlusion 142 includes material deposited on the image sensor 22 (e.g., on the cover glass covering the image sensor 22). The material may include residual oil from a finger of the user 12. For example, the first occlusion 142 may include a smudge on the cover glass as a result of the user 12 touching the cover glass with his/her hands. Additionally or alternatively, the material may have originated from the physical environment 10 (e.g., the material may include dust, an insect, etc.). In the example of FIG. 1D, an occluded area 150 of the image sensor 22 is less than an occlusion threshold 152. In some implementations, when the occluded area 150 is less than the occlusion threshold 152, the electronic device 20 (e.g., the occlusion detection system 200) determines to mitigate the effect of the occlusion (e.g., by lowering a weight of the features corresponding to the occlusion) without notifying the user 12.

FIG. 1E illustrates additional occlusions for the image sensor 22. As the user 12 continues to use the electronic device 20, the image sensor 22 may further be occluded by additional smudges or scratches. In the example of FIG. 1E, the image sensor 22 is occluded by a second occlusion 144 (e.g., another smudge) and a third occlusion 146 (e.g., a scratch). In the example of FIG. 1E, an occluded area 154 exceeds the occlusion threshold 152. For example, a percentage of the image sensor 22 that is covered with smudges, dust or insects may exceed a threshold percentage specified by the occlusion threshold 152. In some implementations, the electronic device 20 (e.g., the occlusion detection system 200) displays a notification 160 that prompts the user 12 to clean the image sensor 22 in response to the occluded area 154 being greater than the occlusion threshold 152. In the example of FIG. 1E, the notification 160 states “Clean camera”.

FIG. 1F illustrates the image sensor 22 after the image sensor 22 has been cleaned. As can be seen in FIG. 1F, cleaning the image sensor 22 has caused some of the occlusions to disappear. In the example of FIGS. 1E and 1F, cleaning the image sensor 22 has removed the first occlusion 142 and the second occlusion 144, for example, because the first occlusion 142 and the second occlusion 144 correspond to smudges that can be removed by cleaning the image sensor 22. However, the third occlusion 146 is still present because the third occlusion 146 corresponds to a scratch that may not be removeable by a simple cleaning of the image sensor 22. Cleaning the image sensor 22 has resulted in an occluded area 156 that is less than the occlusion threshold 152. Since the occluded area 156 is less than the occlusion threshold 152, the electronic device 20 ceases to display the notification 160 shown in FIG. 1E.

Referring to FIG. 1G, as the user 12 continues using the electronic device 20, existing scratches may worsen, and new scratches may develop. In the example of FIG. 1G, a size and an intensity of the third occlusion 146 has increased in comparison to FIG. 1F. The scratch represented by the third occlusion 146 may have widened and elongated overtime. FIG. 1F illustrates a fourth occlusion 148 that corresponds to another scratch. The fourth occlusion 148 represents a scratch that is even wider and longer than the scratch represented by the third occlusion 146. In the example of FIG. 1G, a scratched area 170 covering the image sensor 22 is greater than a scratch threshold 172. For example, a percentage of the cover glass that is scratched is greater than a threshold percentage specified by the scratch threshold 172. In some implementations, the electronic device 20 (e.g., the occlusion detection system 200) displays a notification 180 to replace the electronic device 20 in response to the scratched area 170 being greater than the scratch threshold 172. Since scratches may not be removed by cleaning, replacing the electronic device 20 may be an appropriate measure.

In various implementations, an occlusion refers to material deposited on the image sensor 22 (e.g., material that has accumulated on the cover glass that covers the image sensor 22). The material may include dust, oil from human skin, an insect or another particle that has affixed itself to the image sensor 22. In various implementations, an occlusion refers to an abrasion of the cover glass that is protecting the image sensor 22. For example, the occlusion may include a scratch, a crack, a dent and/or a chipping of the cover glass.

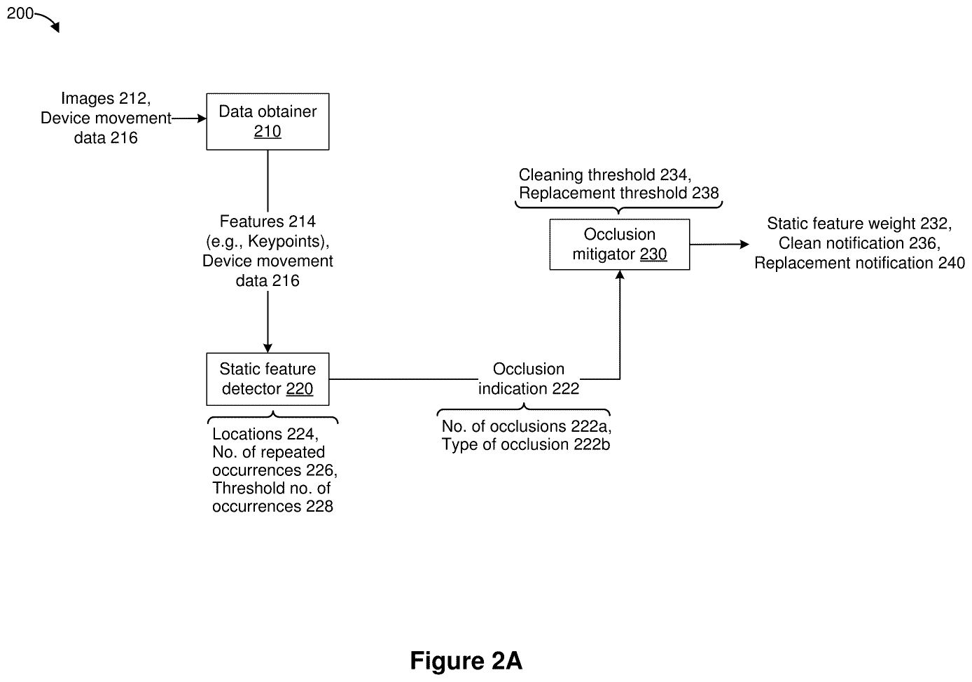

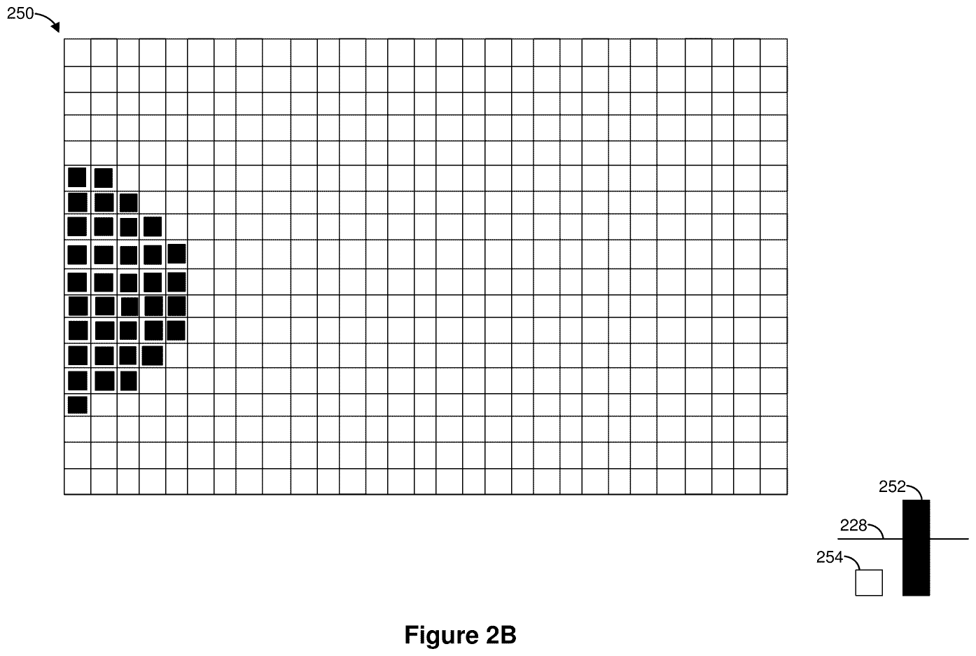

FIG. 2A is a block diagram of the occlusion detection system 200 in accordance with some implementations. In various implementations, the occlusion detection system 200 includes a data obtainer 210, a static feature detector 220 and an occlusion mitigator 230. In some implementations, the data obtainer 210 obtains a set of images 212 (e.g., the first image 100 shown in FIG. 1B and the second image 102 shown in FIG. 1C). The set of images 212 includes a series of images that were captured by an image sensor within a given duration of time. For example, the set of images 212 were captured by the image sensor 22 (shown in FIGS. 1A-1C) within a temporal window of 40 milliseconds.

In some implementations, the data obtainer 210 performs feature detection and extraction on the set of images 212 in order to identify features 214 in the set of images 212. In some implementations, the feature detection and extraction includes generating point clouds. For example, the data obtainer 210 generates the point clouds 130, 132, 134 and 136 shown in FIGS. 1B and 1C. In some implementations, the features 214 are referred to as points, for example, key points that are utilized for SLAM operations. The data obtainer 210 provides an indication of the features 214 to the static feature detector 220.

In some implementations, the data obtainer 210 obtains device movement data 216 that indicates whether or not the device (e.g., the electronic device 20 shown in FIGS. 1A-1G) is moving. In some implementations, the data obtainer 210 receives the device movement data 216 from a motion sensor. For example, the data obtainer 210 may receive the device movement data 216 from an inertial measurement unit (IMU). The data obtainer 210 provides the device movement data 216 to the static feature detector 220. In some implementations, the device movement data 216 includes a binary value that indicates whether or not the device is moving (e.g., a value of ‘1’ to indicate that the device is moving and a value of ‘0’ to indicate that the device is not moving).

In various implementations, the static feature detector 220 determines whether the features 214 detected by the data obtainer 210 include static features that do not move as the device moves within the physical environment. In some implementations, the static feature detector 220 detects static features by tracking respective locations 224 of the features 214. In some implementations, the static feature detector 220 tracks a number of repeated occurrences 226 of each feature 214 at the same location 224. If the number of repeated occurrences 226 for a particular feature 214 exceeds a threshold number of occurrences 228, the static feature detector 220 identifies that particular feature 214 as a static feature that may represent an occlusion instead of a physical object in the physical environment. In some implementations, the number of repeated occurrences 226 has to exceed the threshold number of occurrences 228 within a threshold amount of time (e.g., within 40 milliseconds) in order for the device to determine the presence of an occlusion.

In various implementations, the static feature detector 220 generates an occlusion indication 222 (e.g., the occlusion indication 140 shown in FIG. 1C) in response to determining that one or more of the features 214 is static. In some implementations, the occlusion indication 222 indicates the location 224 of the feature 214 that is static. In some implementations, the occlusion indication 222 includes an indication of a number of occlusions 222a. For example, with reference to FIG. 1E, the static feature detector 220 may indicate that the image sensor 22 is occluded by three occlusions. In some implementations, the occlusion indication 222 includes an indication of a type of occlusion 222b. For example, the occlusion indication 222 indicates whether the occlusion is a result of material being deposited on the cover glass of the image sensor or an abrasion of the cover glass. As an example, with reference to FIG. 1E, the occlusion indication 222 may indicate that the first occlusion 142 and the second occlusion 144 are smudges that can be wiped off, and the third occlusion 146 is a scratch that may not be wiped off.

In some implementations, the static feature detector 220 classifies an occlusion based on an intensity of the corresponding static feature. The intensity of the static feature may refer to a density of points that collectively form the static feature. In some implementations, the static feature detector 220 classifies the occlusion as a material deposit (e.g., a smudge, dust, etc.) when an intensity value associated with the static feature is less than a threshold intensity value. For example, the static feature detector 220 classifies the occlusion as a smudge when the intensity value is less than the threshold (e.g., when a number of points that collectively form the static feature is less than a threshold number of points). In some implementations, the static feature detector 220 classifies the occlusion as an abrasion (e.g., a scratch, a chip, etc.) when an intensity value associated with the static feature is greater than the threshold intensity value. For example, the static feature detector 220 classifies the occlusion as a scratch when the intensity value is greater than the threshold (e.g., when a number of points that collectively form the static feature is greater than a threshold number of points).

In some implementations, the static feature detector 220 classifies an occlusion based on a shape of the corresponding static feature. In some implementations, the static feature detector 220 classifies the occlusion as a material deposit (e.g., a smudge, dust, etc.) when the static feature has a first shape. For example, the static feature detector 220 classifies the occlusion as a smudge when the static feature is oval or circular. In some implementations, the static feature detector 220 classifies the occlusion as an abrasion (e.g., a scratch, a chip, etc.) when the static feature has a second shape. For example, the static feature detector 220 classifies the occlusion as a scratch when the static feature is linear.

In some implementations, the occlusion mitigator 230 mitigates the effects of the occlusion(s) indicated by the occlusion indication 222. In some implementations, the occlusion mitigator 230 mitigates the effects of an occlusion by providing respective static feature weights 232 for static features represented by the occlusion. In some implementations, the static feature weights 232 are lower than weights of non-static features. For example, the static feature weights 232 may be set to zero while the weights of non-static features are greater than zero. The static feature weights 232 reduce an influence of the static features in SLAM operations thereby reducing (e.g., preventing) an adverse impact of occlusions on the SLAM operations. For example, the static feature weights 232 reduce an amount of weight given to static features in a map generation operation or a map updating operation thereby reducing an adverse impact of the occlusion on an accuracy of a resultant map of the physical environment. As another example, the static feature weights 232 reduce an amount of weight given to static features in an object tracking operation thereby reducing an adverse impact of the occlusion on an accuracy of a resultant location of the object being tracked.

In some implementations, the occlusion mitigator 230 increases respective weights for non-static features while maintaining the static feature weights 232. Increasing the weights for non-static features while keeping the static feature weights 232 constant allows the occlusion mitigator 230 to reduce an impact of the static features on downstream operations. In some implementations, the occlusion mitigator 230 modifies at least a portion of the features 214 so that a subset of the features 214 that are static are treated in a different manner than a remainder of the features 214 that are not static. For example, in some implementations, the occlusion mitigator 230 labels a subset of the features 214 that are static so that a function operating on the features 214 can identify the static features based on the labels. In some implementations, the occlusion mitigator 230 masks the static features while leaving the non-static features unmasked. In such implementations, a function operating on the features 214 can forgo operating on the masked features while still operating on the unmasked features. In some implementations, the occlusion mitigator 230 classifies the features 214 into static and non-static, so that a function operating on the features 214 performs different operations on the features 214 based on their respective classifications.

In some implementations, the occlusion mitigator 230 determines whether the occlusion(s) indicated by the occlusion indication 222 satisfy a cleaning threshold 234 (e.g., the occlusion threshold 152 shown in FIGS. 1D-1F). For example, the occlusion mitigator 230 determines whether a number of material deposits on the cover glass indicated by the occlusion indication 222 exceeds a threshold number of material deposits specified by the cleaning threshold 234. As another example, the occlusion mitigator 230 determines whether a covered area (e.g., a smudged area) indicated by the occlusion indication 222 exceeds a threshold area specified by the cleaning threshold 234. In some implementations, the occlusion mitigator 230 generates a clean notification 236 (e.g., the notification 160 shown in FIG. 1E) that prompts the user to clean the cover glass in response to determining that the occlusion(s) indicated by the occlusion indication 222 satisfy the cleaning threshold 234.

In some implementations, the occlusion mitigator 230 determines whether the occlusion(s) indicated by the occlusion indication 222 satisfy a replacement threshold 238 (e.g., the scratch threshold 172 shown in FIG. 1G). For example, the occlusion mitigator 230 determines whether a number of abrasions indicated by the occlusion indication 222 exceeds a threshold number of abrasions specified by the replacement threshold 238. As another example, the occlusion mitigator 230 determines whether a total scratched area indicated by the occlusion indication 222 exceeds a threshold area specified by the replacement threshold 238. In some implementations, the occlusion mitigator 230 generates a replacement notification 240 (e.g., the notification 180 shown in FIG. 1G) that prompts the user to replace the device in response to determining that the abrasion(s) indicated by the occlusion indication 222 satisfy the replacement threshold 238.

FIG. 2B illustrates a 2D LUT 250 that the static feature detector 220 (shown in FIG. 2A) utilizes to track a number of repeated occurrences of a static feature within a threshold amount of time. Each square in the 2D LUT 250 represents a region of the image sensor 22 shown in FIGS. 1A-1G. In some implementations, the static feature detector 220 labels some of the regions as occluded regions 252 in response to encountering static features for a number of times that exceeds the threshold number of occurrences 228 within a threshold amount of time. By contrast, in some implementations, the static feature detector 220 labels some of the regions as unoccluded regions 254 in response to not encountering static features for a number of times that exceeds the threshold number of occurrences 228 within the threshold amount of time.

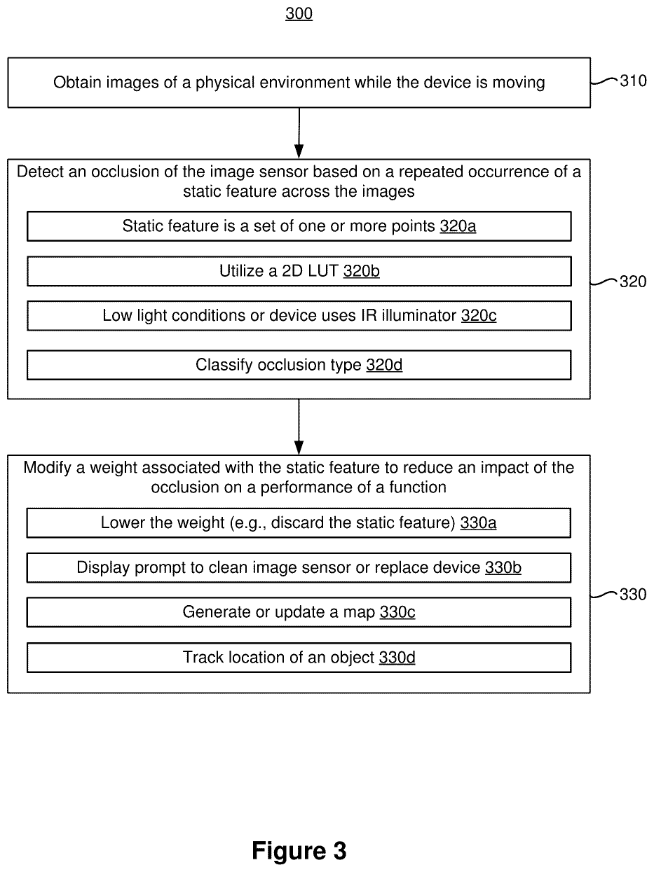

FIG. 3 is a flowchart representation of a method 300 for detecting an occlusion of an image sensor. In various implementations, the method 300 is performed by the electronic device 20 shown in FIGS. 1A-1G and/or the occlusion detection system 200 shown in FIGS. 1A-2. In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes obtaining, via the image sensor, a plurality of images of a physical environment of the electronic device while the electronic device is moving. For example, as shown in FIGS. 1B and 1C, the electronic device 20 captures a series of images (e.g., the first image 100 shown in FIG. 1B and the second image 102 shown in FIG. 1C) via the image sensor 22. In some implementations, the electronic device captures the images as part of a SLAM operation. For example, the electronic device captures images in response to receiving a request to generate and/or update a map of a physical environment (e.g., the physical environment 10 shown in FIG. 1A). As another example, the electronic device captures images in response to receiving a request to track a location of a physical object within a physical environment (e.g., the drone 34 shown in FIG. 1A). In some implementations, the electronic device is being moved by a user of the device during capture of the plurality of images of the physical environment. Alternatively, in some implementations, the electronic device is mounted on a moveable rig (e.g., a human-controlled rig or an autonomous rig) and the rig moves the electronic device during capture of the plurality of images of the physical environment.

As represented by block 320, in various implementations, the method 300 includes detecting an occlusion of the image sensor based on a repeated occurrence of a static feature across the plurality of images. For example, as described in relation to FIGS. 1B and 1C, the occlusion detection system 200 detects an occlusion of the image sensor 20 based on a repeated occurrence of the fourth point cloud 136 across a series of images that includes the first image 100 and the second image 102. As another example, the static feature detector 220 detects an occlusion of the image sensor when the location 224 of a particular feature 214 has a number of repeated occurrences 226 that is greater than the threshold number of occurrences 228.

As represented by block 320a, in some implementations, the static feature includes a set of one or more points. For example, as shown in FIG. 1C, the fourth point cloud 136 includes a collection of points. In some implementations, the static feature is a set of one or more key points that are used for performing a SLAM operation. In some implementations, the method 300 includes performing feature detection and/or extraction on each of the plurality of images to generate respective point clouds. For example, as shown in FIGS. 1B and 1C, the electronic device 20 (e.g., the data obtainer 210 shown in FIG. 2A) performs feature detection and/or extraction on the first image 100 shown in FIG. 1B and the second image 102 shown in FIG. 1C in order to generate the point clouds 130, 132, 134 and 136.

In some implementations, detecting the occlusion includes determining that a number of occurrences of the static feature exceeds a threshold number of occurrences. For example, as described in relation to FIG. 2A, the static feature detector 220 determines that a particular feature 214 is a static feature that corresponds to an occlusion in response to the number of repeated occurrences 226 of that particular feature 214 at the same location 224 being greater than the threshold number of occurrences 228.

As represented by block 320b, in some implementations, detecting the occlusion includes utilizing a two-dimensional (2D) look-up table (LUT) to track occurrences of features across the plurality of images. For example, as shown in FIG. 2B, in some implementations, the static feature detector 220 utilizes the 2D LUT 250 to track repeated occurrences of features across a series of images. In some implementations, the device determines that a particular feature represents an occlusion when the feature appears static over a set of consecutive images that were captured within a threshold amount of time.

As represented by block 320c, in some implementations, detecting the occlusion includes detecting the occlusion when an ambient lighting level is less than a threshold lighting level. Low light tends to exacerbate the adverse effects of occlusions on feature detection and extraction. For example, the features tend to be more pronounced in low light conditions. As such, the electronic device may perform occlusion detection when the ambient lighting level is less than the threshold lighting level, and the electronic device may forgo performing occlusion detection when the ambient lighting level is greater than the threshold lighting level in order to conserve power associated with occlusion detection.

In some implementations, detecting the occlusion includes detecting the occlusion when an infrared (IR) illuminator is present behind a cover glass. In some devices the IR illuminator and the image sensor share a common cover glass. In such devices, IR light emitted by the IR illuminator reflects off an inside surface of the cover glass and is captured by the image sensor. Additionally, the image sensor may detect a reflection of the IR illuminator off the inside surface of the cover glass. In order to reduce the adverse effects of detecting the reflection, the electronic device performs occlusion detection when the electronic device includes an IR illuminator and the IR illuminator is activated during image capture in a low-lighting situation. In order to conserve resources associated with occlusion detection, the electronic device may forgo performing occlusion detection when the electronic device does not include an IR illuminator or when the IR illuminator is not activated.

As represented by block 320d, in some implementations, the method 300 includes classifying the occlusion into one of a plurality of occlusion types. For example, as discussed in relation to FIG. 2A, the occlusion indication 222 may indicate the type of occlusion 222b. In some implementations, classifying the occlusion includes classifying the occlusion based on an intensity of the static feature representing the occlusion. In some implementations, the electronic device classifies an occlusion represented by a relatively low intensity feature into a material deposit (e.g., a smudge) and an occlusion represented by a relatively high intensity feature into an abrasion (e.g., a scratch). In some implementations, the electronic device classifies an occlusion based on a shape of the static feature representing the occlusion. For example, the electronic device classifies an occlusion represented by a collection of features that appears to be circular or oval as a smudge, and the electronic device classifies an occlusion represented by a collection of features that appears to be linear as a scratch. As an example, referring to FIG. 1E, the occlusion detection system 200 classifies the first occlusion 142 and the second occlusion 144 as smudges, and the third occlusion 146 as a scratch.

As represented by block 330, in various implementations, the method 300 includes modifying a weight associated with the static feature to reduce an impact of the occlusion on a performance of a function. For example, in some implementations, the method 300 includes lowering the weight of the static feature in order to reduce an adverse impact of the occlusion in a localization and mapping operation associated with the physical environment. Modifying (e.g., lowering) the weight of the static feature tends to reduce an adverse impact of a corresponding occlusion on a performance of a function such as a localization and mapping operation, an object detection operation, an object tracking operation, etc. For example, as shown in FIG. 2A, the occlusion mitigator 230 generates the static feature weights 232 in order to mitigate the occlusion(s) indicated by the occlusion indication 222. Reducing the adverse impact of the occlusion tends to increase a performance of the function. For example, reducing the adverse impact of the occlusion may increase an accuracy of an object detection function (e.g., by reducing false positives). As another example, reducing the adverse impact of the occlusion may increase a reliability of an object tracking function (e.g., by providing a more precise location of an object being tracked). As yet another example, reducing the adverse impact of the occlusion may increase an accuracy of a mapping operation (e.g., by generating a map that more closely represents the physical environment).

As represented by block 330a, in some implementations, modifying the weight includes lowering the weight of the static feature. In some implementations, modifying the weight includes discarding the static feature. Discarding the static feature allows the electronic device to reduce (e.g., eliminate) an adverse effect of a corresponding occlusion on an accuracy of the function being performed on the images (e.g., discarding the static feature tends to increase an accuracy of a localization and mapping operation). For example, discarding the static feature prevents a mapping operation from including a representation of a physical object in a map when the physical environment does not in fact include the physical object.

As represented by block 330b, in some implementations, the method 300 includes prompting to clean the image sensor when the occlusion satisfies a cleaning criterion (e.g., the cleaning threshold 234 shown in FIG. 2A). For example, as shown in FIG. 1E, the electronic device 20 displays the notification 160 that prompts the user 12 to clean the image sensor 22. In some implementations, the electronic device generates the notification when a portion of the image sensor that is occluded is greater than a threshold portion (e.g., when the occluded area 154 is greater than the occlusion threshold 152 shown in FIG. 1E). The electronic device forgoes displaying a prompt to clean when the occlusion does not satisfy the cleaning criterion in order to limit a number of prompts that are displayed since displaying an excessive number of prompts may detract from a user experience provided by the electronic device.

In some implementations, the method 300 includes prompting to replace the image sensor when the occlusion satisfies a replacement criterion (e.g., the replacement threshold 238 shown in FIG. 2A). For example, as shown in FIG. 1G, the electronic device 20 displays the notification 180 that prompts the user 12 to replace the electronic device 20. In some implementations, the electronic device generates the notification when a portion of the image sensor that is scratched exceeds a threshold portion (e.g., when the scratched area 170 is greater than the scratch threshold 172). The electronic device forgoes displaying a prompt to replace when the occlusion does not satisfy the replacement criterion in order to limit a number of prompts and to extend a usage of the electronic device.

As represented by block 330c, in some implementations, the localization and mapping operation includes generating or updating a map of the physical environment. For example, as described in relation to FIG. 1A, in some implementations, the electronic device 20 utilizes images captured by the image sensor 22 to generate and/or update a map of the physical environment 10.

As represented by block 330d, in some implementations, the localization and mapping operation includes tracking a location of an object in the physical environment. For example, as described in relation to FIG. 1A, in some implementations, the electronic device 20 utilizes images captured by the image sensor 22 to track the location of a physical object in the physical environment 10 (e.g., to track the location of the drone 34 within the physical environment 10).

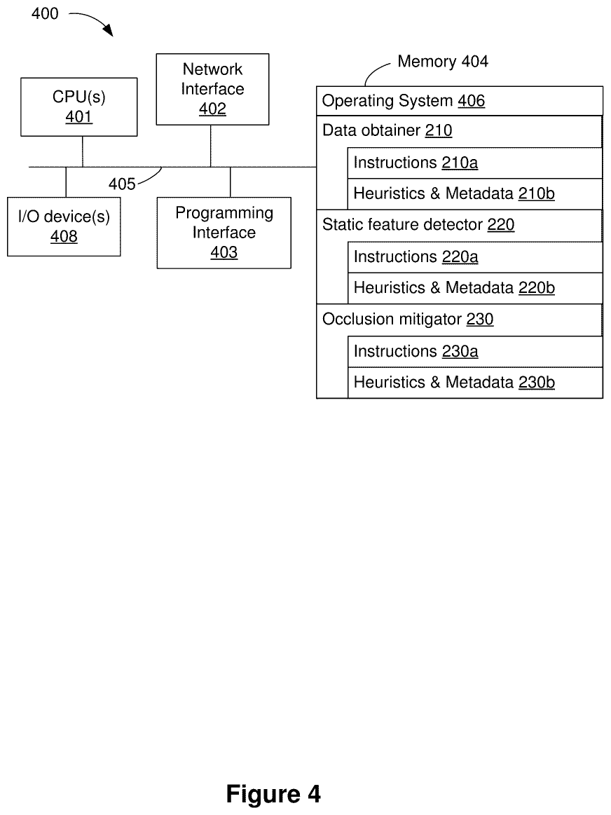

FIG. 4 is a block diagram of a device 400 in accordance with some implementations. In some implementations, the device 400 implements the electronic device 20 shown in FIGS. 1A-1G and/or the occlusion detection system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 408, and one or more communication buses 405 for interconnecting these and various other components.

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 401. The memory 404 comprises a non-transitory computer readable storage medium.

In some implementations, the one or more I/O devices 408 include a display. In some implementations, the display includes an extended reality (XR) display. In some implementations, the display includes an opaque display. Alternatively, in some implementations, the display includes an optical see-through display. In some implementations, the one or more I/O devices 408 include an image sensor (e.g., the image sensor 22 shown in FIGS. 1A-1G). The image sensor may include a visible light camera and/or an infrared light camera for capturing image data.

In some implementations, the memory 404 or the non-transitory computer readable storage medium of the memory 404 stores the following programs, modules and data structures, or a subset thereof including an optional operating system 406, the data obtainer 210, the static feature detector 220 and the occlusion mitigator 230.

In various implementations, the data obtainer 210 includes instructions 210a, and heuristics and metadata 210b for obtaining images of a physical environment (e.g., the first image 100 shown in FIG. 1B and the second image 102 shown in FIG. 1C). In some implementations, the static feature detector 220 includes instructions 220a, and heuristics and metadata 220b for detecting an occlusion of the image sensor based on a repeated occurrence of a static feature across a series of images captured by the image sensor (e.g., for detecting that the fourth point cloud 136 shown in FIG. 1C is static and corresponds to an occlusion of the image sensor 22). In some implementations, the occlusion mitigator 230 includes instructions 230a, and heuristics and metadata 230b for modifying a weight associated with the static feature to decrease an impact of the occlusion on a performance of a function. (e.g., by lowering respective weights associated with the fourth point cloud 136 shown in FIG. 1C, for example, by discarding the fourth point cloud 136).

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at an electronic device including a non-transitory memory, one or more processors, a display and an image sensor:
obtaining, via the image sensor, a plurality of images of a physical environment of the electronic device while the electronic device is moving;
detecting an occlusion of the image sensor based on a repeated occurrence of a static feature across the plurality of images; and
modifying a weight associated with the static feature to decrease an impact of the occlusion on a performance of a function.

2. The method of claim 1, wherein the static feature includes a set of one or more points.

3. The method of claim 2, further comprising performing feature generation and extraction on each of the plurality of images to generate respective point clouds.

4. The method of claim 1, wherein detecting the occlusion comprises utilizing a two-dimensional (2D) look-up table (LUT) to track occurrences of features across the plurality of images.

5. The method of claim 1, wherein detecting the occlusion comprises determining that a number of occurrences of the static feature exceeds a threshold number of occurrences.

6. The method of claim 1, wherein detecting the occlusion comprises detecting the occlusion when an ambient lighting level is less than a threshold lighting level.

7. The method of claim 1, wherein detecting the occlusion comprises detecting the occlusion when an infrared (IR) illuminator is located within a threshold distance of the image sensor.

8. The method of claim 1, further comprising classifying the occlusion into one of a plurality of occlusion types.

9. The method of claim 8, wherein classifying the occlusion comprises classifying the occlusion based on an intensity of the static feature.

10. The method of claim 8, wherein classifying the occlusion comprises classifying the occlusion based on a shape of the static feature.

11. The method of claim 1, wherein modifying the weight associated with the static feature comprises lowering the weight of the static feature.

12. The method of claim 1, wherein modifying the weight associated with the static feature comprises discarding the static feature.

13. The method of claim 1, further comprising prompting to clean the image sensor when the occlusion satisfies a cleaning criterion.

14. The method of claim 1, further comprising prompting to replace the electronic device when the occlusion satisfies a replacement criterion.

15. The method of claim 1, wherein the function comprises a localization and mapping operation.

16. The method of claim 15, wherein the localization and mapping operation includes generating or updating a map of the physical environment.

17. The method of claim 15, wherein the localization and mapping operation includes tracking a location of an object in the physical environment.

18. The method of claim 1, wherein the function comprises tracking an object.

19. An electronic device comprising:
a display;
an image sensor;
one or more processors;
a non-transitory memory; and
one or more programs stored in the non-transitory memory, which, when executed by the one or more processors, cause the device to;
obtain, via the image sensor, a plurality of images of a physical environment of the electronic device while the electronic device is moving;
detect an occlusion of the image sensor based on a repeated occurrence of a static feature across the plurality of images; and
modify a weight associated with the static feature to decrease an impact of the occlusion on a performance of a function.

20. A non-transitory memory storing one or more programs, which, when executed by one or more processors of a device with an image sensor, cause the device to:
obtain, via the image sensor, a plurality of images of a physical environment of the electronic device while the electronic device is moving;
detect an occlusion of the image sensor based on a repeated occurrence of a static feature across the plurality of images; and
modify a weight associated with the static feature to decrease an impact of the occlusion on a performance of a function.
